(19) United States
(12) Patent Application Publication
(10) Pub. No.: US 2016/0288107 A1
(43) Pub. Date: Oct. 6, 2016

(54) ALUMINOSILICATE OR SILICOALUMINOPHOSPHATE MOLECULAR SIEVE/ MANGANESE OCTAHEDRAL MOLECULAR SIEVE AS CATALYSTS FOR TREATING EXHAUST GAS

(71) Applicant: JOHNSON MATTHEY PUBLIC LIMITED COMPANY, London (GB)

(72) Inventors: John KILMARTIN, Reading (GB); Janet Mary FISHER, Reading (GB); Jillian Elaine COLLIER, Reading (GB); David THOMPSETT, Reading (GB); Raj Rao RAJARAM, Reading (GB)

(21) Appl. No.: 15/031,002

(22) PCT Filed: Mar. 14, 2014
(86) PCT No.: PCT/IB2014/059834

§ 371 Date: Apr. 21, 2016

Related U.S. Application Data
(60) Provisional application No. 61/784,870, filed on Mar. 14, 2013.

(51) Int. Cl. B01J 29/04; B01J 29/76; B01D 53/94; B01J 29/80; B01J 35/00; B01J 35/04; B01J 29/08; B01J 29/06

(52) U.S. Cl. CPC B01J 29/045; B01J 29/084; B01J 29/7615; B01J 29/06; B01J 29/80; B01J 35/0006; B01J 35/04; B01D 53/9418; B01D 2251/2062; B01D 2255/50; B01D 2255/502; B01D 2255/9032

(57) ABSTRACT

Catalysts and articles useful for selective catalytic reduction (SCR) and other exhaust gas treatments are disclosed. The catalysts comprise an octahedral molecular sieve (OMS) comprising manganese oxide and an aluminosilicate and/or silicoaluminophosphate large-pore or medium-pore molecular sieve.

### FIELD OF THE INVENTION

The invention relates to catalysts useful for treating an exhaust gas, and in particular, to aluminosilicate or silicoaluminophosphate/manganese octahedral molecular sieves.

### BACKGROUND OF THE INVENTION

Hydrocarbon combustion in diesel engines, stationary gas turbines, and other systems generates exhaust gas that must be treated to remove nitrogen oxides (NOx), including NO, NO₂, and N₂O. The exhaust generated in lean-burn engines is generally oxidative, and the NOx needs to be reduced selectively with a heterogeneous catalyst and a reductant, which is typically ammonia or a short-chain hydrocarbon. The process, known as selective catalytic reduction (SCR), has been thoroughly investigated.

Many known SCR catalysts utilize a transition metal (e.g., Cu, Fe, or V) coated on a high-porosity support, such as alumina or a zeolite. For instance, WO 02/41991 describes pretreated metal-promoted β-zeolites for an SCR process. U.S. Pat. Appl. Publ. No. 2011/0250127 teaches that commonly used transition metal zeolites include Cu/ZSM-5, Cu/β-zeolite, Fe/ZSM-5, Fe/β-zeolite, and the like. These zeolite catalysts are said to be prone to hydrocarbon adsorption and coking. The reference concludes that small-pore zeolites having certain transition metals can provide good conversion of NOx in an NH₃-SCR process while having good thermal stability, low hydrocarbon adsorption, and low N₂O formation. Zeolites are a well-known variety of molecular sieves that are mostly regular frameworks built from TO₄ tetrahedra, in which T is typically silicon, aluminum, or phosphorus.

Manganese oxide octahedral molecular sieves (“OMS”) are also known. As the name suggests, octahedral units combine to make the overall structure, which is characterized by one-dimensional channels. Some manganese oxide OMS occur in nature, including hollandites (hollandite, cryptomelane, manjiroite, coronadite) and the poorly crystalline todorokites. Manganese oxide OMS have also been synthesized (see, e.g., U.S. Pat. Nos. 5,340,562; 5,523,509; 5,545,393; 5,578,282; 5,635,155; and 5,702,674 and R. DeGuzman et al., Chem. Mater. 6 (1994) 815). In some cases, some of the manganese in the framework of an OMS can be substituted with other metal ions. This is usually accomplished by doping other ions in the process used to make the manganese oxide OMS. For instance, U.S. Pat. No. 5,702,674 teaches to substitute Fe, Cu, Mo, Zn, La, or other metals for Mn in the framework of a manganese oxide OMS. As this reference teaches, manganese oxide OMS are potentially useful for reducing nitric oxide with ammonia, although relatively little is known about their use for an SCR process.

Natural manganese ores (hollandite, cryptomelane) have been used for low-temperature SCR of nitrogen oxides with ammonia (see, e.g., Tae Sung Park et al., Ind. Eng. Chem. Res. 40 (2001) 4491).

Manganese oxide OMS catalysts have some drawbacks. For instance, the OMS catalysts can be thermally unstable such that NOx conversion can diminish rapidly as the catalyst ages or is exposed to high temperatures. Moreover, the low-temperature NOx conversion, i.e., at temperatures from 100° C. to 250° C., is typically less than desirable. This is important because lean-burn engines—which are characterized by air/fuel ratios >15, typically 19-50—generate considerable NOx immediately after start-up when the exhaust gas temperature is at its lowest. Manganese oxide OMS catalysts can also generate N₂O during the NOx conversion process, and ideally the amount of N₂O formed could be minimized.

More recently, other metals have been suggested for use as dopants for manganese oxide OMS. For instance, vanadium-doped cryptomelane-type manganese oxides (V-OMS-2) have been synthesized and used for low-temperature SCR or NO by ammonia (NH₃-SCR) (see Liang Sun et al., Appl. Catal. A 393 (2011) 323). Similarly, Chao Wang et al. describe hollandite-type manganese oxides with K+ or H+ in the tunnels and their use for low-temperature NH₃-SCR (Appl. Catal. B 101 (2011) 598.

Despite the ubiquity of large-pore zeolites and transition metal-containing zeolites, they do not appear to have been used in combination with manganese OMS catalysts in an SCR process, particularly an NH₃-SCR process. The industry would benefit from improved SCR catalysts, particularly low-temperature NH₃-SCR catalysts.

### SUMMARY OF THE INVENTION

In one aspect, the invention relates to a catalyst that is useful for selective catalytic reduction. The catalyst comprises 1 to 99 wt. % of an octahedral molecular sieve (OMS) comprising manganese oxide and 1 to 99 wt. % of a large-pore and/or medium-pore zeolite(s). In another aspect, the invention relates to an SCR process. The process comprises selectively reducing a gaseous mixture comprising nitrogen oxides in the presence of a reductant and the manganese oxide OMS/large-pore and/or medium-pore zeolite(s) catalyst described above. Articles useful for SCR comprising the catalyst and a substrate are also included.

We surprisingly found that the manganese oxide OMS/large-pore zeolite catalysts and manganese oxide OMS/medium-pore zeolite catalysts offer advantages for selective catalytic reduction, especially NH₃-SCR. In particular, the catalysts offer improved NOx conversions at temperatures greater than 300° C. and reduced N₂O formation at temperatures from 150° C. to 400° C. compared with the results available using similar manganese oxide OMS catalysts made without a large-pore zeolite. Compared with a large-pore zeolite catalyst alone (without the manganese oxide OMS), the inventive catalysts provide improved NOx conversions at low temperatures (150° C. to 250° C.). Moreover, a synergistic effect exists when manganese oxide OMS and large or medium-pore zeolites are used in combination. For example, such combinations yield higher NOx conversion over useful temperature ranges (e.g., 250-400 deg. C.) compared to either of the components individually.

### BRIEF DESCRIPTION OF THE DRAWINGS

FIG. 1 is a plot of N₂O formation versus temperature for an OMS-2/β-zeolite composite catalyst of the invention and a comparative catalyst based on OMS-2 alone.

FIG. 2 plots NOx conversion versus temperature for an OMS-2/β-zeolite composite catalyst of the invention and a comparative catalyst based on OMS-2 alone.

FIG. 3 plots N₂O formation versus temperature for comparative catalysts based on OMS-2 alone or a 1:1 physical mixture of OMS-2 and cordierite.

FIG. 4 plots NOx conversion versus temperature for comparative catalysts based on OMS-2 alone or a 1:1 physical mixture of OMS-2 and cordierite.

FIG. 5 plots N₂O formation versus temperature for various OMS-2/5% Fe on β-zeolite catalysts of the invention and comparative catalysts based on OMS-2 alone or Fe on β-zeolite alone.

FIG. 6 plots NOx conversion versus temperature for various OMS-2/5% Fe on β-zeolite catalysts of the invention and comparative catalysts based on OMS-2 alone or Fe on β-zeolite alone.

FIG. 7 shows the effect of calcination conditions on the N₂O formation versus temperature plot for various OMS-2/5% Fe on β-zeolite catalysts of the invention.

FIG. 8 shows the effect of calcination conditions on the NOx conversion versus temperature plot for various OMS-2/5% Fe on β-zeolite catalysts of the invention.

FIG. 9 plots N₂O formation versus temperature for composite catalysts of OMS-2 and large-pore zeolites of the invention and comparative catalysts based on OMS-2 alone.

FIG. 10 plots NOx conversion versus temperature for composite catalysts of OMS-2 and large-pore zeolites of the invention and comparative catalysts based on OMS-2 alone.

FIG. 11 plots N₂O formation versus temperature for thermally aged composite catalysts of OMS-2 and large-pore zeolites of the invention and comparative catalysts based on OMS-2 alone or OMS-2 and a small-pore zeolite.

FIG. 12 plots NOx conversion versus temperature for thermally aged composite catalysts of OMS-2 and large-pore zeolites of the invention and comparative catalysts based on OMS-2 alone or OMS-2 and a small-pore zeolite.

FIG. 13 plots N₂O formation versus temperature for various OMS-2/β-zeolite, OMS-2/FER-zeolite, and OMS-2/ZSM5-zeolite catalysts of the invention and comparative catalysts based on OMS-2 alone or OMS-2/CHA-zeolite.

FIG. 14 plots NOx conversion versus temperature for various OMS-2/β-zeolite, OMS-2/FER-zeolite, and OMS-2/ZSM5-zeolite catalysts of the invention and comparative catalysts based on OMS-2 alone or OMS-2/CHA-zeolite.

### DETAILED DESCRIPTION OF THE INVENTION

Catalysts of the invention comprise a large-pore zeolite and a manganese oxide octahedral molecular sieve.

Suitable octahedral molecular sieves for use in making the inventive catalysts are natural or synthetic compositions comprising principally manganese oxides. Manganese oxide octahedral molecular sieves (“OMS”) occur in nature as todorokite, hollandite (BaMn₈O₁₆), cryptomelane (KMn₈O₁₆), manjiroite (NaMn₈O₁₆), and coronandite (PbMn₈O₁₆). The minerals have a three-dimensional framework tunnel structure assembled from MnO₆ octahedra and are distinguished by which cation resides in the tunnels.

Preferably, the OMS is synthesized. Methods developed by Professor Steven Suib and coworkers and reported in many scientific papers and patents can be used. See, for example: U.S. Pat. Nos. 5,340,562; 5,523,509; 5,545,393; 5,578,282; 5,635,155; 5,702,674; 6,797,247; 7,153,345; and 7,700,517, the teachings of which are incorporated herein by reference. See also: R. DeGuzman et al., Chem. Mater. 6 (1994) 815). Synthetic octahedral molecular sieves are preferred for selective catalytic reduction and other catalytic processes because they have substantially homogeneous tunnel structures as opposed to the more randomly distributed structures of the natural minerals.

The tunnel structure of the OMS will vary depending on the synthetic approach used. For example, OMS-2, which has the (2×2) tunnel structure of hollandite, can be prepared in a hydrothermal reaction of manganese sulfate, nitric acid, and potassium permanganate (see U.S. Pat. No. 5,702,674). In contrast, OMS-1 has the (3×3) tunnel structure of todorokites and can be prepared by adding a magnesium permanganate solution to basic manganese(II) hydroxide, followed by aging and washing steps (see, e.g., U.S. Pat. No. 5,340,562). OMS having a (4×4) tunnel structure can also be used (see, e.g., U.S. Pat. No. 5,578,282), as well as OMS having a (2×3) structure (see, e.g., U.S. Pat. No. 6,797,247). If desired, the framework of the OMS can be substituted with other metals (see, e.g., U.S. Pat. No. 5,702,674). Octahedral molecular sieves having (2×2) and (3×3) tunnel structure are particularly preferred for an SCR process. OMS-2 is particularly preferred.

Typically, a source of manganese cation (e.g., MnCl₂, Mn(NO₃)₂, MnSO₄, Mn(OAc)₂, etc.), a source of permanganate ion and counter cation (e.g., alkali metal or alkaline earth metal permanganates), and any framework-substituting metal cation source are combined and reacted under conditions of temperature, pressure, pH, and other factors effective to give a manganese oxide OMS having the desired structure. The mixture can be heated in a closed system, generating autogenous pressure, or the reaction can be performed under atmospheric conditions.

The OMS are principally manganese oxide-based. Thus >50 mol %, preferably >75%, and more preferably >95%, of the metal cations present in the framework structure of the OMS are manganese cations. These amounts include any amount of doped metal cation, but not amounts of metals that may be deposited on the surface of the OMS.

The molar ratio of permanganate ion to manganese cation is often important in determining the nature of the resulting OMS. The ratio of concentrations [MnO₄⁻¹]/[Mn⁺²] is preferably within the range of 0.05 to 3.0, with low ratios (0.3-0.4) being ideal for making todorokites and somewhat higher ratios (0.1-1.5) being more preferred for making hollandites.

The pH also influences the nature of the OMS produced. Low pH (0 to 4) is preferred for making hollandites, while a high pH (>13) is desirable for making todorokites.

Reaction temperatures for making the OMS can vary over a wide range and can also be used to influence the type of product generated. Generally, the temperature can be within the range of 25° C. to 300° C., with 70° C. to 160° C. being preferred for making hollandite OMS structures, and 130° C. to 170° C. being preferred for making todorokites.

The manganese oxide OMS may be doped with a metal to improve activity, impart thermal stability, expand the useful temperature range for NOx conversion, reduce N₂O make, or achieve other objectives. This is typically accomplished by including an aqueous solution containing a water-soluble metal salt in the preparation of the OMS. Preferred metals for doping include Ca, Ti, V, Cr, Fe, Co, Ni, Cu, Zn, Ce, Zr, Mo, W, and Pr. Particularly preferred are Cu, Ce, Fe, and W. In certain aspects, the invention the manganese oxide OMS, with the exception of Mn is free or essentially free of metals free or essentially free of transition metals, free or essentially free of noble metals, free or essentially free of alkali metals, free or essentially free of alkaline earth metals, and/or free or essentially free of rare earth metals. In certain aspects, the invention the manganese oxide OMS comprises Ce. In certain aspects, the invention the manganese oxide OMS is free or essentially free of Ce.

Other oxides and mixed oxides can be incorporated into the catalyst, including titanias, zirconias, silicas, aluminas, silica-aluminas, niobias, and the like, and mixtures thereof.

Catalysts of the invention include medium-pore or large-pore molecular sieves such as zeolites (i.e., aluminosilicates) and silicoaluminophosphates (SAPOs), with zeolites being preferred in some applications. Preferred catalysts have a molecular sieve framework structure that includes at least 10-membered rings (i.e., medium-pore molecular sieves), or preferably includes at least 12-membered rings (i.e., large-pore molecular sieves). Suitable large-pore molecular sieve include β-zeolites, Y zeolites, ultra-stable Y zeolites (USY), dealuminized Y zeolites, X zeolites, mordenite, ZSM-3, ZSM-4, ZSM-18, ZSM-20, and the like. See U.S. Pat. Nos. 3,923,636, 3,972,983, 3,308,069, 3,293,192, 3,449,070, 3,442,795, and 4,401,556, the teachings of which are incorporated herein by reference, for examples of large-pore molecular sieve and their methods of preparation. Preferred large-pore molecular sieve are β-zeolites, Y zeolites, and ultra-stable Y zeolites, with β-zeolites being more preferred. Suitable medium-pore molecular sieves include those having a framework selected from FER, MFI, OFF, FAU, or MOR, such as ZSM-5 or ferrierite.

As used herein the term “zeolite” means a synthetic aluminosilicate molecular sieve having a framework constructed of alumina and silica (i.e., repeating SiO₄ and AlO₄ tetrahedral units), and preferably having a molar silica-to-alumina ratio (SAR) of at least 8, for example about 10 to about 50. The zeolites of the present invention are not silica-aluminophosphates (SAPOs) and thus do not have an appreciable amount of phosphorous in their framework.

In certain aspects, zeolite crystals of the invention are of uniform size and shape with relatively low amounts of agglomeration. Such zeolite crystals can have a mean crystalline size of about 0.1 to about 10 μm, for example about 0.5 to about 5 μm, about 0.1 to about 1 μm, about 1 to about 5 μm, about 3 to about 7 μm, and the like. Direct measurement of the crystal size can be performed using microscopy methods, such as SEM and TEM. In certain embodiments, large crystals are milled using a jet mill or other particle-on-particle milling technique to an average size of about 1.0 to about 1.5 micron to facilitate washcoating a slurry containing the catalyst to a substrate, such as a flow-through monolith.

The medium-pore and large-pore molecular sieve can be a metal-exchanged zeolite, particularly a transition metal-exchanged molecular sieve. Preferably, the medium-pore and large-pore molecular sieve do not contain framework transition metals in an appreciable amount. Instead, the transition metal is present as an ionic species within the interior channels and cavities of the molecular sieve framework. Accordingly, the transition metal-containing zeolite is not a metal-substituted zeolite (e.g., a zeolite having a metal substituted into its framework structure) but instead could be a metal-exchanged zeolite (e.g., a zeolite that underwent a post synthesis ion exchange of transition metal). In certain embodiments, the metal is present during zeolite synthesis, but is not incorporated into the zeolite framework. In certain embodiments, the zeolite is free or essentially free of metals other than copper, iron, and aluminum.

Examples of metals that can be post-molecular sieve synthesis exchanged or impregnated include transition metals, including copper, nickel, zinc, iron, tungsten, molybdenum, cobalt, titanium, zirconium, manganese, chromium, vanadium, niobium, as well as tin, bismuth, and antimony; noble metals including platinum group metals (PGMs), such as ruthenium, rhodium, palladium, indium, platinum, and precious metals such as gold and silver; alkaline earth metals such as beryllium, magnesium, calcium, strontium, and barium; and rare earth metals such as lanthanum, cerium, praseodymium, neodymium, europium, terbium, erbium, ytterbium, and yttrium. Preferred transition metals for post-synthesis exchange are base metals, and preferred base metals include those selected from the group consisting of manganese, iron, cobalt, nickel, and mixtures thereof. Metals incorporated post-synthesis can be added to the molecular sieve via any known technique such as ion exchange, impregnation, isomorphous substitution, etc. The amount of metal post-synthesis exchanged on the zeolite can be from about 0.1 to about 20 weight percent, for example about 1 to about 10 weight percent, about 0.1 to about 1.5 weight percent, or about 2 to about 6 weight percent based on the total weight of the zeolite.

The relative amounts of manganese oxide OMS and medium-pore or large-pore molecular sieve can vary over a wide range. Thus, suitable catalysts comprise 1 to 99 wt. % of the OMS and 1 to 99 wt. % of the large-pore molecular sieve. Preferably, the catalysts comprise 10 to 90 wt. % of the OMS and 10 to 90 wt. % of the large-pore zeolite. More preferred catalysts comprise 30 to 70 wt. % of the OMS and 30 to 70 wt. % of the medium-pore or large-pore molecular sieve.

The catalysts can be prepared by a variety of techniques. In some cases, a simple physical mixture of the manganese oxide OMS and the medium-pore or large-pore zeolite may be most suitable. Typically, the components are combined in the desired mass ratio and calcined prior to use. In some cases, one or more of the individual components (OMS and/or molecular sieve) might be calcined prior to their combination.

In another approach, a suspension or dispersion of OMS is deposited on a zeolite, and the mixture is concentrated, dried, and calcined. Similarly, a suspension or dispersion of the large-pore molecular sieve could be deposited on OMS, followed by concentration, drying, and calcination. These methods might be desirable when a small proportion of one of the zeolite or OMS components is used (e.g., 1 to 5 wt. % of OMS on a large-pore zeolite or 1 to 5 wt. % of the large pore or medium pore zeolite on a manganese oxide OMS).

In another approach, a composite catalyst is made. In one example, the manganese oxide OMS is synthesized in the presence of a suspended or dispersed medium pore or large-pore molecular sieve. Alternatively, the medium pore or large-pore zeolite could be synthesized in the presence of a suspended or dispersed pre-formed manganese oxide OMS. In some cases, it may even be desirable to synthesize the OMS and the medium pore or large-pore molecular sieve at substantially the same time in a “one pot” process.

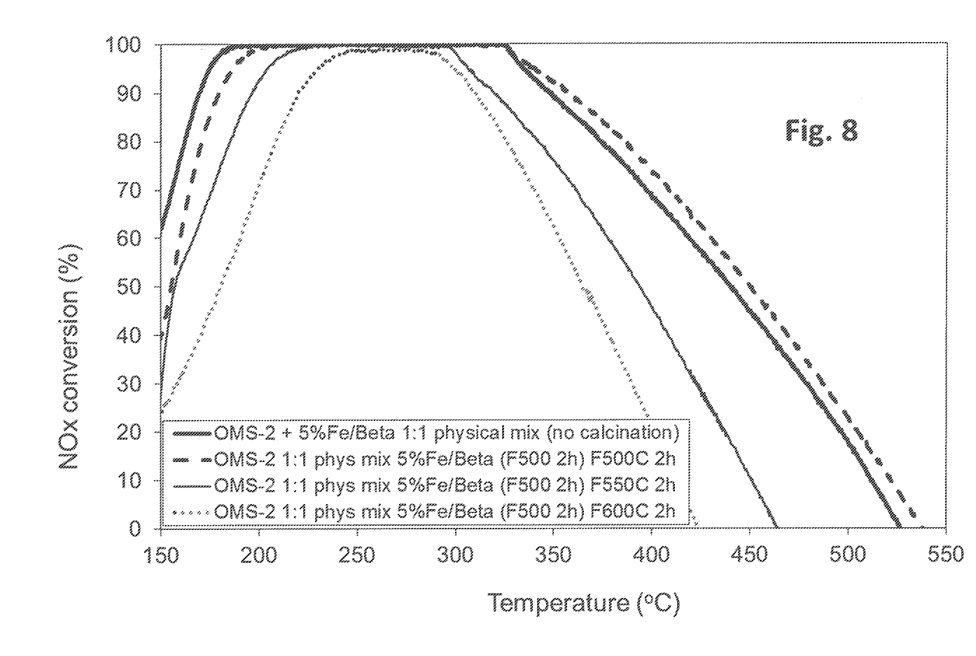

It is usually desirable to calcine the inventive catalysts prior to use in an SCR process. Preferably, calcination is performed by heating the catalyst in an oxygen-containing atmosphere, typically air, at a temperature within the range of 300° C. to 750° C., more preferably 400° C. to 700° C., and most preferably 500° C. to 600° C. As shown in FIG. 8, a high calcination temperature may deactivate the catalyst toward NOx reduction or narrow the temperature window for acceptable NOx conversion.

The catalyst can be used in any desired form, such as powders, pellets, extrudates, or as a coating or film deposited on a support or substrate.

Following catalyst preparation, it may be desirable to homogenize the powders before testing. Thus, powder samples of freshly prepared catalysts may be pelletized, pulverized, and passed through a sieve (e.g., a 255-350 μm sieve) prior to testing or use.

Catalysts of the present invention are particularly applicable for heterogeneous catalytic reaction systems (i.e., solid catalyst in contact with a gas reactant). To improve contact surface area, mechanical stability, and/or fluid flow characteristics, the catalysts can be disposed on and/or within a substrate, preferably a porous substrate. In certain embodiments, a washcoat containing the catalyst is applied to an inert substrate, such as corrugated metal plate or a honeycomb cordierite brick. Alternatively, the catalyst is kneaded along with other components such as fillers, binders, and reinforcing agents, into an extrudable paste which is then extruded through a die to form a honeycomb brick. Accordingly, in certain embodiments provided is a catalyst article comprising a catalyst described herein coated on and/or incorporated into a substrate.

Certain aspects of the invention provide a catalytic washcoat. The washcoat comprising the catalyst described herein is preferably a solution, suspension, or slurry. Suitable coatings include surface coatings, coatings that penetrate a portion of the substrate, coatings that permeate the substrate, or some combination thereof.

A washcoat can also include non-catalytic components, such as fillers, binders, stabilizers, rheology modifiers, and other additives, including one or more of alumina, silica, non-zeolite silica alumina, titania, zirconia, ceria. In certain embodiments, the catalyst composition may comprise pore-forming agents such as graphite, cellulose, starch, polyacrylate, and polyethylene, and the like. These additional components do not necessarily catalyze the desired reaction, but instead improve the catalytic material's effectiveness, for example, by increasing its operating temperature range, increasing contact surface area of the catalyst, increasing adherence of the catalyst to a substrate, etc. In preferred embodiments, the washcoat loading is >0.3 g/in³, such as >1.2 g/in³, >1.5 g/in³, >1.7 g/in³ or >2.00 g/in³, and preferably <3.5 g/in³, such as <2.5 g/in³. In certain embodiments, the washcoat is applied to a substrate in a loading of about 0.8 to 1.0 g/in³, 1.0 to 1.5 g/in³, or 1.5 to 2.5 g/in³.

Two of the most common substrate designs are plate and honeycomb. Preferred substrates, particularly for mobile applications, include flow-through monoliths having a so-called honeycomb geometry that comprise multiple adjacent, parallel channels that are open on both ends and generally extend from the inlet face to the outlet face of the substrate and result in a high-surface area-to-volume ratio. For certain applications, the honeycomb flow-through monolith preferably has a high cell density, for example about 600 to 800 cells per square inch, and/or an average internal wall thickness of about 0.18-0.35 mm, preferably about 0.20-0.25 mm. For certain other applications, the honeycomb flow-through monolith preferably has a low cell density of about 150-600 cells per square inch, more preferably about 200-400 cells per square inch. Preferably, the honeycomb monoliths are porous. In addition to cordierite, silicon carbide, silicon nitride, ceramic, and metal, other materials that can be used for the substrate include aluminum nitride, silicon nitride, aluminum titanate, α-alumina, mullite, e.g., acicular mullite, pollucite, a thermet such as Al₂OsZFe, Al₂O₃/Ni or B₄CZFe, or composites comprising segments of any two or more thereof. Preferred materials include cordierite, silicon carbide, and alumina titanate.

Plate-type catalysts have lower pressure drops and are less susceptible to plugging and fouling than the honeycomb types, which is advantageous in high efficiency stationary applications, but plate configurations can be much larger and more expensive. A honeycomb configuration is typically smaller than a plate type, which is an advantage in mobile applications, but has higher pressure drops and plug more easily. In certain embodiments the plate substrate is constructed of metal, preferably corrugated metal.

In certain embodiments, the invention is a catalyst article made by a process described herein. In a particular embodiment, the catalyst article is produced by a process that includes the steps of applying the catalyst composition, preferably as a washcoat, to a substrate as a layer either before or after at least one additional layer of another composition for treating exhaust gas has been applied to the substrate. The one or more catalyst layers on the substrate, including the present catalyst layer, are arranged in consecutive layers. As used herein, the term “consecutive” with respect to catalyst layers on a substrate means that each layer is contact with its adjacent layer(s) and that the catalyst layers as a whole are arranged one on top of another on the substrate.

In certain embodiments, the present catalyst is disposed on the substrate as a first layer and another composition, such as an oxidation catalyst, reduction catalyst, scavenging component, or NOₓ storage component, is disposed on the substrate as a second layer. In other embodiments, the present catalyst is disposed on the substrate as a second layer and another composition, such as such as an oxidation catalyst, reduction catalyst, scavenging component, or NOₓ storage component, is disposed on the substrate as a first layer. As used herein the terms “first layer” and “second layer” are used to describe the relative positions of catalyst layers in the catalyst article with respect to the normal direction of exhaust gas flow-through, past, and/or over the catalyst article. Under normal exhaust gas flow conditions, exhaust gas contacts the first layer prior to contacting the second layer. In certain embodiments, the second layer is applied to an inert substrate as a bottom layer and the first layer is top layer that is applied over the second layer as a consecutive series of sub-layers. In such embodiments, the exhaust gas penetrates (and hence contacts) the first layer, before contacting the second layer, and subsequently returns through the first layer to exit the catalyst component. In other embodiments, the first layer is a first zone disposed on an upstream portion of the substrate and the second layer is disposed on the substrate as a second zone, wherein the second zone is downstream of the first.

In another embodiment, the catalyst article is produced by a process that includes the steps of applying the present catalyst composition, preferably as a washcoat, to a substrate as a first zone, and subsequently applying at least one additional composition for treating an exhaust gas to the substrate as a second zone, wherein at least a portion of the first zone is downstream of the second zone. Alternatively, the present catalyst composition can be applied to the substrate in a second zone that is downstream of a first zone containing the additional composition. Examples of additional compositions include oxidation catalysts, reduction catalysts, scavenging components (e.g., for sulfur, water, etc.), or NOₓ storage components.

To reduce the amount of space required for an exhaust system, individual exhaust components in certain embodiments are designed to perform more than one function. For example, applying an SCR catalyst to a wall-flow filter substrate instead of a flow-through substrate serves to reduce the overall size of an exhaust treatment system by allowing one substrate to serve two functions, namely catalytically reducing NOₓ concentration in the exhaust gas and mechanically removing soot from the exhaust gas. Accordingly, in certain embodiments, the substrate is a honeycomb wall-flow filter or partial filter. Wall-flow filters are similar to flow-through honeycomb substrates in that they contain a plurality of adjacent, parallel channels. However, the channels of flow-through honeycomb substrates are open at both ends, whereas the channels of wall-flow substrates have one end capped, wherein the capping occurs on opposite ends of adjacent channels in an alternating pattern. Capping alternating ends of channels prevents the gas entering the inlet face of the substrate from flowing straight through the channel and existing. Instead, the exhaust gas enters the front of the substrate and travels into about half of the channels where it is forced through the channel walls prior to entering the second half of the channels and exiting the back face of the substrate.

The substrate wall has a porosity and pore size that is gas permeable, but traps a major portion of the particulate matter, such as soot, from the gas as the gas passes through the wall. Preferred wall-flow substrates are high efficiency filters. Wall flow filters for use with the present invention preferably have an efficiency of least 70%, at least about 75%, at least about 80%, or at least about 90%. In certain embodiments, the efficiency will be from about 75 to about 99%, about 75 to about 90%, about 80 to about 90%, or about 85 to about 95%. Here, efficiency is relative to soot and other similarly sized particles and to particulate concentrations typically found in conventional diesel exhaust gas. For example, particulates in diesel exhaust can range in size from 0.05 microns to 2.5 microns. Thus, the efficiency can be based on this range or a sub-range, such as 0.1 to 0.25 microns, 0.25 to 1.25 microns, or 1.25 to 2.5 microns.

Porosity is a measure of the percentage of void space in a porous substrate and is related to backpressure in an exhaust system: generally, the lower the porosity, the higher the backpressure. Preferably, the porous substrate has a porosity of about 30 to about 80%, for example about 40 to about 75%, about 40 to about 65%, or from about 50 to about 60%.

The pore interconnectivity, measured as a percentage of the substrate's total void volume, is the degree to which pores, void, and/or channels, are joined to form continuous paths through a porous substrate, i.e., from the inlet face to the outlet face. In contrast to pore interconnectivity is the sum of closed pore volume and the volume of pores that have a conduit to only one of the surfaces of the substrate. Preferably, the porous substrate has a pore interconnectivity volume of at least about 30%, more preferably at least about 40%.

The mean pore size of the porous substrate is also important for filtration. Mean pore size can be determined by any acceptable means, including by mercury porosimetry. The mean pore size of the porous substrate should be of a high enough value to promote low backpressure, while providing an adequate efficiency by either the substrate per se, by promotion of a soot cake layer on the surface of the substrate, or combination of both. Preferred porous substrates have a mean pore size of about 10 to about 40 μm, for example about 20 to about 30 μm, about 10 to about 25 μm, about 10 to about 20 μm, about 20 to about 25 μm, about 10 to about 15 μm, and about 15 to about 20 μm.

In general, the production of an extruded solid body containing the catalyst involves blending the catalyst, a binder, an optional organic viscosity-enhancing compound into an homogeneous paste which is then added to a binder/matrix component or a precursor thereof and optionally one or more of stabilized ceria, and inorganic fibers. The blend is compacted in a mixing or kneading apparatus or an extruder. The mixtures have organic additives such as binders, pore formers, plasticizers, surfactants, lubricants, dispersants as processing aids to enhance wetting and therefore produce a uniform batch. The resulting plastic material is then molded, in particular using an extrusion press or an extruder including an extrusion die, and the resulting moldings are dried and calcined. The organic additives are “burnt out” during calcinations of the extruded solid body. The catalyst may also be washcoated or otherwise applied to the extruded solid body as one or more sub-layers that reside on the surface or penetrate wholly or partly into the extruded solid body.

Extruded solid bodies containing the catalysts according to the present invention generally comprise a unitary structure in the form of a honeycomb having uniform-sized and parallel channels extending from a first end to a second end thereof. Channel walls defining the channels are porous. Typically, an external “skin” surrounds a plurality of the channels of the extruded solid body. The extruded solid body can be formed from any desired cross section, such as circular, square or oval. Individual channels in the plurality of channels can be square, triangular, hexagonal, circular etc. Channels at a first, upstream end can be blocked, e.g. with a suitable ceramic cement, and channels not blocked at the first, upstream end can also be blocked at a second, downstream end to form a wall-flow filter. Typically, the arrangement of the blocked channels at the first, upstream end resembles a checker-board with a similar arrangement of blocked and open downstream channel ends.

The binder/matrix component is preferably selected from the group consisting of cordierite, nitrides, carbides, borides, intermetallics, lithium aluminosilicate, a spinel, an optionally doped alumina, a silica source, titania, zirconia, titania-zirconia, zircon and mixtures of any two or more thereof. The paste can optionally contain reinforcing inorganic fibers selected from the group consisting of carbon fibers, glass fibers, metal fibers, boron fibers, alumina fibers, silica fibers, silica-alumina fibers, silicon carbide fibers, potassium titanate fibers, aluminum borate fibers and ceramic fibers.

The alumina binder/matrix component is preferably gamma alumina, but can be any other transition alumina, i.e., alpha alumina, beta alumina, chi alumina, eta alumina, rho alumina, kappa alumina, theta alumina, delta alumina, lanthanum beta alumina and mixtures of any two or more such transition aluminas. It is preferred that the alumina is doped with at least one non-aluminum element to increase the thermal stability of the alumina. Suitable alumina dopants include silicon, zirconium, barium, lanthanides and mixtures of any two or more thereof. Suitable lanthanide dopants include La, Ce, Nd, Pr, Gd and mixtures of any two or more thereof.

Sources of silica can include a silica sol, quartz, fused or amorphous silica, sodium silicate, an amorphous aluminosilicate, an alkoxysilane, a silicone resin binder such as methylphenyl silicone resin, a clay, talc or a mixture of any two or more thereof. Of this list, the silica can be SiO₂ as such, feldspar, mullite, silica-alumina, silica-magnesia, silica-zirconia, silica-thoria, silica-berylia, silica-titania, ternary silica-alumina-zirconia, ternary silica-alumina-magnesia, ternary-silica-magnesia-zirconia, ternary silica-alumina-thoria and mixtures of any two or more thereof.

Preferably, the catalyst is dispersed throughout, and preferably evenly throughout, the entire extruded catalyst body.

Where any of the above extruded solid bodies are made into a wall-flow filter, the porosity of the wall-flow filter can be from 30-80%, such as from 40-70%. Porosity and pore volume and pore radius can be measured e.g. using mercury intrusion porosimetry.

The catalyst described herein can promote the reaction of a reductant, preferably ammonia, with nitrogen oxides to selectively form elemental nitrogen (N₂) and water (H₂O). Thus, in one embodiment, the catalyst can be formulated to favor the reduction of nitrogen oxides with a reductant (i.e., an SCR catalyst). Examples of such reductants include hydrocarbons (e.g., C3-C6 hydrocarbons) and nitrogenous reductants such as ammonia and ammonia hydrazine or any suitable ammonia precursor, such as urea ((NH₂)₂CO), ammonium carbonate, ammonium carbamate, ammonium hydrogen carbonate or ammonium formate.

The zeolite catalyst described herein can also promote the oxidation of ammonia. Thus, in another embodiment, the catalyst can be formulated to favor the oxidation of ammonia with oxygen, particularly a concentrations of ammonia typically encountered downstream of an SCR catalyst (e.g., ammonia oxidation (AMOX) catalyst, such as an ammonia slip catalyst (ASC)). In certain embodiments, the present catalyst is disposed as a top layer over an oxidative under-layer, wherein the under-layer comprises a platinum group metal (PGM) catalyst or a non-PGM catalyst. Preferably, the catalyst component in the underlayer is disposed on a high surface area support, including but not limited to alumina.

In yet another embodiment, an SCR and AMOX operations are performed in series, wherein both processes utilize a catalyst comprising the catalyst described herein, and wherein the SCR process occurs upstream of the AMOX process. For example, an SCR formulation of the catalyst can be disposed on the inlet side of a filter and an AMOX formulation of the catalyst can be disposed on the outlet side of the filter.

Accordingly, provided is a method for the reduction of NOₓ compounds or oxidation of NH₃ in a gas, which comprises contacting the gas with a catalyst composition described herein for the catalytic reduction of NOₓ compounds for a time sufficient to reduce the level of NOₓ compounds and/or NH₃ in the gas. In certain embodiments, provided is a catalyst article having an ammonia slip catalyst disposed downstream of a selective catalytic reduction (SCR) catalyst. In such embodiments, the ammonia slip catalyst oxidizes at least a portion of any nitrogenous reductant that is not consumed by the selective catalytic reduction process. For example, in certain embodiments, the ammonia slip catalyst is disposed on the outlet side of a wall flow filter and an SCR catalyst is disposed on the upstream side of a filter. In certain other embodiments, the ammonia slip catalyst is disposed on the downstream end of a flow-through substrate and an SCR catalyst is disposed on the upstream end of the flow-through substrate. In other embodiments, the ammonia slip catalyst and SCR catalyst are disposed on separate bricks within the exhaust system. These separate bricks can be adjacent to, and in contact with, each other or separated by a specific distance, provided that they are in fluid communication with each other and provided that the SCR catalyst brick is disposed upstream of the ammonia slip catalyst brick.

In certain embodiments, the SCR and/or AMOX process is performed at a temperature of at least 100° C. In another embodiment, the process(es) occur at a temperature from about 150° C. to about 750° C. In a particular embodiment, the temperature range is from about 175 to about 550° C. In another embodiment, the temperature range is from 175 to 400° C. In yet another embodiment, the temperature range is 450 to 900° C., preferably 500 to 750° C., 500 to 650° C., 450 to 550° C., or 650 to 850° C. Embodiments utilizing temperatures greater than 450° C. are particularly useful for treating exhaust gases from a heavy and light duty diesel engine that is equipped with an exhaust system comprising (optionally catalyzed) diesel particulate filters which are regenerated actively, e.g. by injecting hydrocarbon into the exhaust system upstream of the filter, wherein the zeolite catalyst for use in the present invention is located downstream of the filter.

According to another aspect of the invention, provided is a method for the reduction of NO_{X} compounds and/or oxidation of NH₃ in a gas, which comprises contacting the gas with a catalyst described herein for a time sufficient to reduce the level of NO_{X} compounds in the gas. Methods of the present invention may comprise one or more of the following steps: (a) accumulating and/or combusting soot that is in contact with the inlet of a catalytic filter; (b) introducing a nitrogenous reducing agent into the exhaust gas stream prior to contacting the catalytic filter, preferably with no intervening catalytic steps involving the treatment of NOₓ and the reductant; (c) generating NH₃ over a NOₓ adsorber catalyst or lean NOₓ trap, and preferably using such NH₃ as a reductant in a downstream SCR reaction; (d) contacting the exhaust gas stream with a DOC to oxidize hydrocarbon based soluble organic fraction (SOF) and/or carbon monoxide into CO₂, and/or oxidize NO into NO₂, which in turn, may be used to oxidize particulate matter in particulate filter; and/or reduce the particulate matter (PM) in the exhaust gas; (e) contacting the exhaust gas with one or more flow-through SCR catalyst device(s) in the presence of a reducing agent to reduce the NOx concentration in the exhaust gas; and (f) contacting the exhaust gas with an ammonia slip catalyst, preferably downstream of the SCR catalyst to oxidize most, if not all, of the ammonia prior to emitting the exhaust gas into the atmosphere or passing the exhaust gas through a recirculation loop prior to exhaust gas entering/re-entering the engine.

In another embodiment, all or at least a portion of the nitrogen-based reductant, particularly NH₃, for consumption in the SCR process can be supplied by a NO_{X} adsorber catalyst (NAC), a lean NO_{X} trap (LNT), or a NO_{X} storage/reduction catalyst (NSRC), disposed upstream of the SCR catalyst, e.g., a SCR catalyst of the present invention disposed on a wall-flow filter. NAC components useful in the present invention include a catalyst combination of a basic material (such as alkali metal, alkaline earth metal or a rare earth metal, including oxides of alkali metals, oxides of alkaline earth metals, and combinations thereof), and a precious metal (such as platinum), and optionally a reduction catalyst component, such as rhodium. Specific types of basic material useful in the NAC include cesium oxide, potassium oxide, magnesium oxide, sodium oxide, calcium oxide, strontium oxide, barium oxide, and combinations thereof. The precious metal is preferably present at about 10 to about 200 g/ft³, such as 20 to 60 g/ft³. Alternatively, the precious metal of the catalyst is characterized by the average concentration which may be from about 40 to about 100 grams/ft³.

Under certain conditions, during the periodically rich regeneration events, NH₃ may be generated over a NOₓ adsorber catalyst. The SCR catalyst downstream of the NOₓ adsorber catalyst may improve the overall system NOₓ reduction efficiency. In the combined system, the SCR catalyst is capable of storing the released NH₃ from the NAC catalyst during rich regeneration events and utilizes the stored NH₃ to selectively reduce some or all of the NOₓ that slips through the NAC catalyst during the normal lean operation conditions.

The method for treating exhaust gas as described herein can be performed on an exhaust gas derived from a combustion process, such as from an internal combustion engine (whether mobile or stationary), a gas turbine and coal or oil fired power plants. The method may also be used to treat gas from industrial processes such as refining, from refinery heaters and boilers, furnaces, the chemical processing industry, coke ovens, municipal waste plants and incinerators, etc. In a particular embodiment, the method is used for treating exhaust gas from a vehicular lean burn internal combustion engine, such as a diesel engine, a lean-burn gasoline engine or an engine powered by liquid petroleum gas or natural gas.

In certain aspects, the invention is a system for treating exhaust gas generated by combustion process, such as from an internal combustion engine (whether mobile or stationary), a gas turbine, coal or oil fired power plants, and the like. Such systems include a catalytic article comprising the catalyst described herein and at least one additional component for treating the exhaust gas, wherein the catalytic article and at least one additional component are designed to function as a coherent unit.

In certain embodiments, the system comprises a catalytic article comprising a catalyst described herein, a conduit for directing a flowing exhaust gas, a source of nitrogenous reductant disposed upstream of the catalytic article. The system can include a controller for the metering the nitrogenous reductant into the flowing exhaust gas only when it is determined that the zeolite catalyst is capable of catalyzing NOₓ reduction at or above a desired efficiency, such as at above 100° C., above 150° C. or above 175° C. The metering of the nitrogenous reductant can be arranged such that 60% to 200% of theoretical ammonia is present in exhaust gas entering the SCR catalyst calculated at 1:1 NH₃/NO and 4:3 NH₃/NO₂.

In another embodiment, the system comprises an oxidation catalyst (e.g., a diesel oxidation catalyst (DOC)) for oxidizing nitrogen monoxide in the exhaust gas to nitrogen dioxide can be located upstream of a point of metering the nitrogenous reductant into the exhaust gas. In one embodiment, the oxidation catalyst is adapted to yield a gas stream entering the SCR zeolite catalyst having a ratio of NO to NO₂ of from about 4:1 to about 1:3 by volume, e.g. at an exhaust gas temperature at oxidation catalyst inlet of 250° C. to 450° C. The oxidation catalyst can include at least one platinum group metal (or some combination of these), such as platinum, palladium, or rhodium, coated on a flow-through monolith substrate. In one embodiment, the at least one platinum group metal is platinum, palladium or a combination of both platinum and palladium. The platinum group metal can be supported on a high surface area washcoat component such as alumina, a zeolite such as an aluminosilicate zeolite, silica, non-zeolite silica alumina, ceria, zirconia, titania or a mixed or composite oxide containing both ceria and zirconia.

The following examples merely illustrate the invention; the skilled person will recognize many variations that are within the spirit of the invention and scope of the claims.

### Synthesis of OMS-2

Manganese sulfate hydrate (44.0 g, 0.26 mol) is dissolved in a mixture of water (150 mL) and concentrated nitric acid (12 mL) in a round-bottom flask fitted with a condenser and magnetic stir bar. A solution of potassium permanganate (29.5 g, 0.185 mol) in water (500 mL) is added, and the mixture is refluxed for 16 h over a period of three days (day one: 6.5 h; day two: 7.5 h; day three: 2 h). Solids are recovered by filtration and washed with water until the conductivity is about 20 μS. The product is dried at 105° C. Yield: 41.2 g. The catalyst is calcined at either 500° C. (“F500C”) for 2 h or 600° C. (“F600C”) for 2 h prior to use.

### Preparation of 5% Fe on β-Zeolite

A 5 wt. % iron on a commercially available β-zeolite catalyst is prepared using an incipient wetness technique as follows: The amount of iron nitrate (Fe(NO₃)₃.9H₂O) needed to give a 5 wt. % Fe loading is dissolved in deionized water. The total volume of solution is equivalent to the pore volume of the sample. The solution is added to the β-zeolite and the resulting mixture is dried overnight at 105° C. and is then calcined in air at 500° C. for 1 h.

### Preparation of Physical Mixtures of OMS-2 and 5% Fe on β-Zeolite

The OMS-2 and 5% Fe on β-zeolite catalysts prepared as described above are combined in a 2:1, 1:1, or 1:2 mass ratio, and the physical mixtures are calcined at 500° C., 550° C., or 600° C. for 2 h.

### Preparation of OMS-2/β-Zeolite (1:1) Composite

Manganese sulfate hydrate (11.02 g, 0.065 mol) is dissolved in a mixture of water (37.5 mL) and concentrated nitric acid (3.0 mL) in a round-bottom flask fitted with a condenser and magnetic stir bar. Once the manganese sulfate has dissolved, β-zeolite (10.0 g) is added to form a pink slurry, which is stirred until homogeneous. A solution of potassium permanganate (7.36 g, 0.047 mol) in water (125 mL) is added, and the mixture is refluxed overnight. The solids are recovered by filtration and washed with water until the conductivity is about 20 μS. The product is dried at 105° C. Yield: about 20 g. The composite catalyst is calcined at 500° C. for 2 h prior to use. For some experiments, the catalyst is further calcined at 600° C. for 2 h.

### Preparation of OMS-2/USY (1:1) Composite

The procedure used to prepare the OMS-2/β-zeolite composite is used, except that ultra-stable Y-zeolite is used instead of β-zeolite. The composite catalyst is calcined at 500° C. for 2 h prior to use. For some experiments, the catalyst is further calcined at 600° C. for 2 h.

### Physical Mixture of OMS-2 and Cordierite

Pre-pelletized cordierite is physically mixed in a 1:1 mass ratio with pre-pelletized OMS-2 that had been calcined at 500° C. for 2 h.

### NH₃-SCR Activity Test Conditions

Powder samples of catalysts are obtained by pelletizing the original samples, crushing the pellets, and then passing the resulting powder through a 255-350 μm sieve. The sieved powders are loaded into a synthetic catalyst activity test (SCAT) reactor and tested using the following synthetic diesel exhaust gas mixture (at inlet) including ammonia as the reductant: 350 ppm NO, 385 ppm NH₃, 12% O₂, 4.5% CO₂, 4.5% H₂O, balance N₂ at a space velocity of 30,000 h⁻¹.

Samples are heated gradually from 150° C. to 550° C. at 5° C./min, and the composition of the off-gases is analyzed using FTIR spectroscopy to determine the % conversion of NOx gases.

### Results

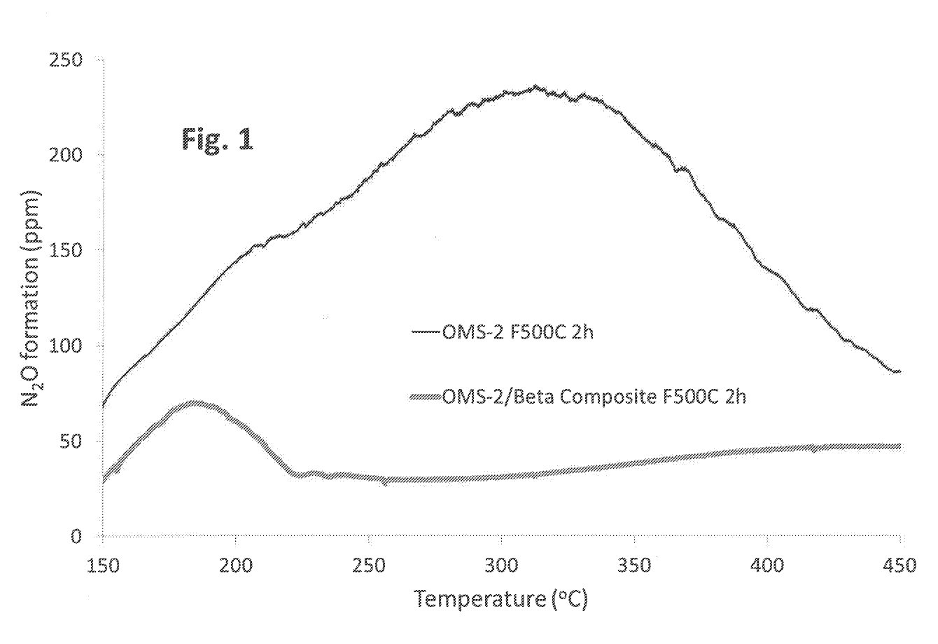

FIG. 1 shows that a composite catalyst made by synthesizing OMS-2 in the presence of β-zeolite generates far less N₂O than an OMS-2 catalyst alone. The N₂O reduction is surprising and beneficial because although OMS catalysts were known to give N₂O, it was unclear how to minimize or avoid N₂O formation when using them.

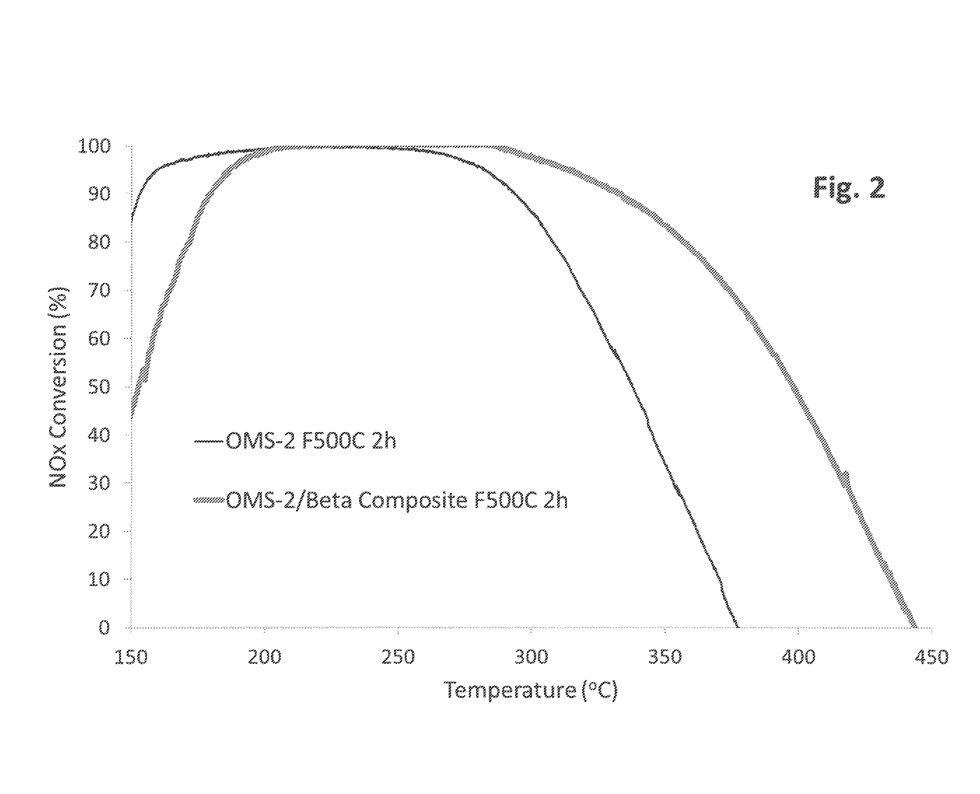

FIG. 2 shows that the temperature range for NOx conversion is broadened when using the composite catalyst of OMS-2 and β-zeolite. In particular, the high-temperature range (300° C. to 400° C.) is extended for the composite, albeit at the expense of some loss at the low-temperature end (150° C. to 200° C.).

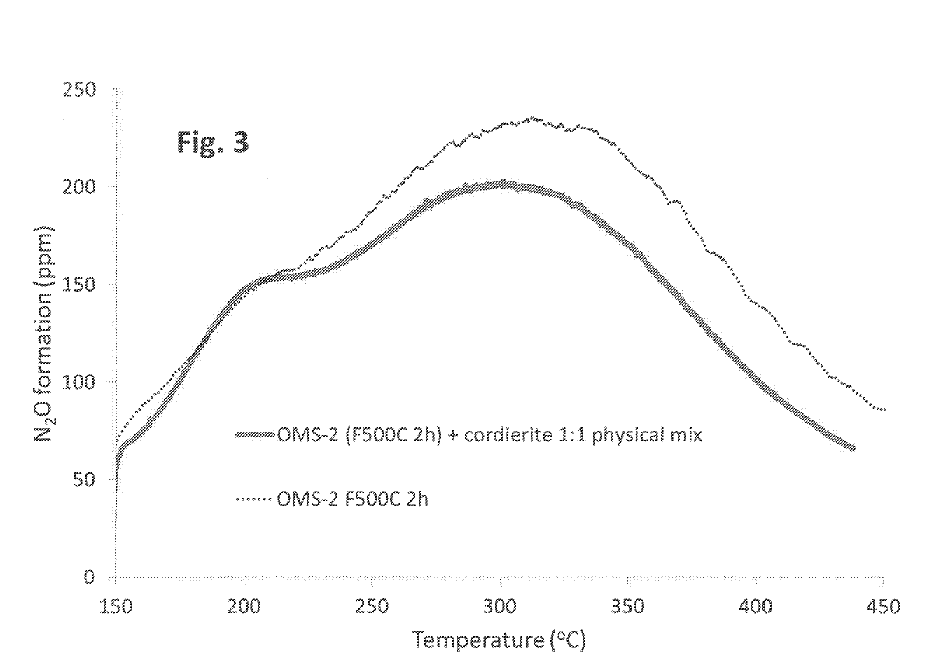

FIG. 3 is a comparative plot showing that a 1:1 physical mixture of OMS-2 and cordierite is ineffective in reducing the N₂O formation seen with OMS-2 alone. In fact, the 1:1 mixture generates as much N₂O as OMS-2 alone.

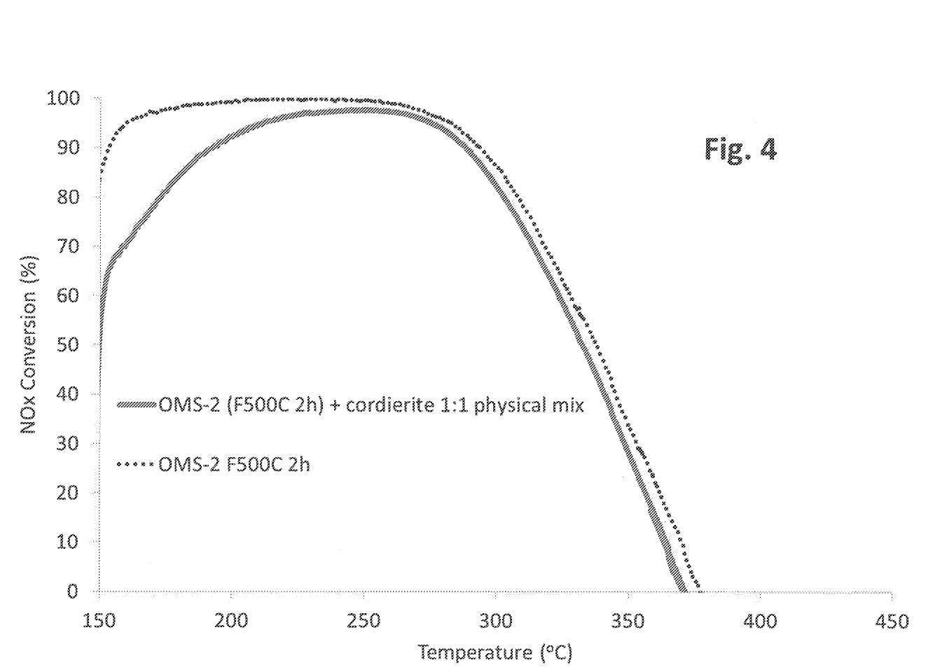

FIG. 4 is another comparative plot. It shows that a 1:1 physical mixture of OMS-2 and cordierite, unlike the OMS-2/β-zeolite composite, is ineffective in extending the high-temperature range for NOx conversion. The OMS-2/cordierite mixture is also somewhat less effective than OMS-2 for NOx conversion at low temperatures (150° C. to 250° C.).

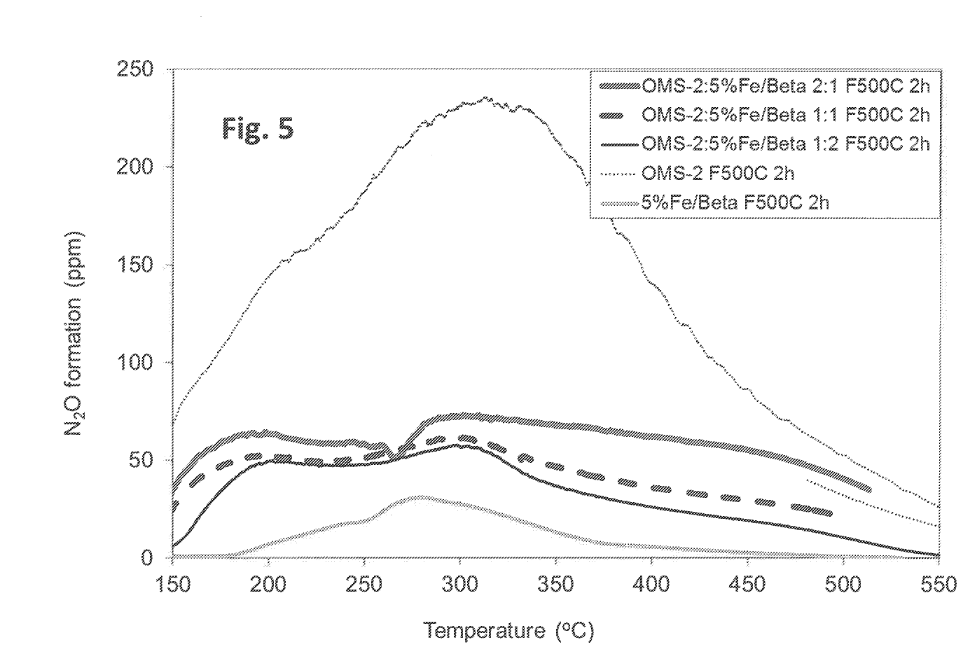

FIG. 5 illustrates the effect of combining OMS-2 with 5 wt. % iron on β-zeolite at various weight ratios. All of the OMS-2/Fe β-zeolite mixtures succeed in reducing N₂O formation compared with OMS-2 alone. A higher proportion of β-zeolite (1 part OMS-2 to 2 parts of Fe β-zeolite) appears to afford the least N₂O make. The comparative plot of 5% Fe on β-zeolite also shows low N₂O formation.

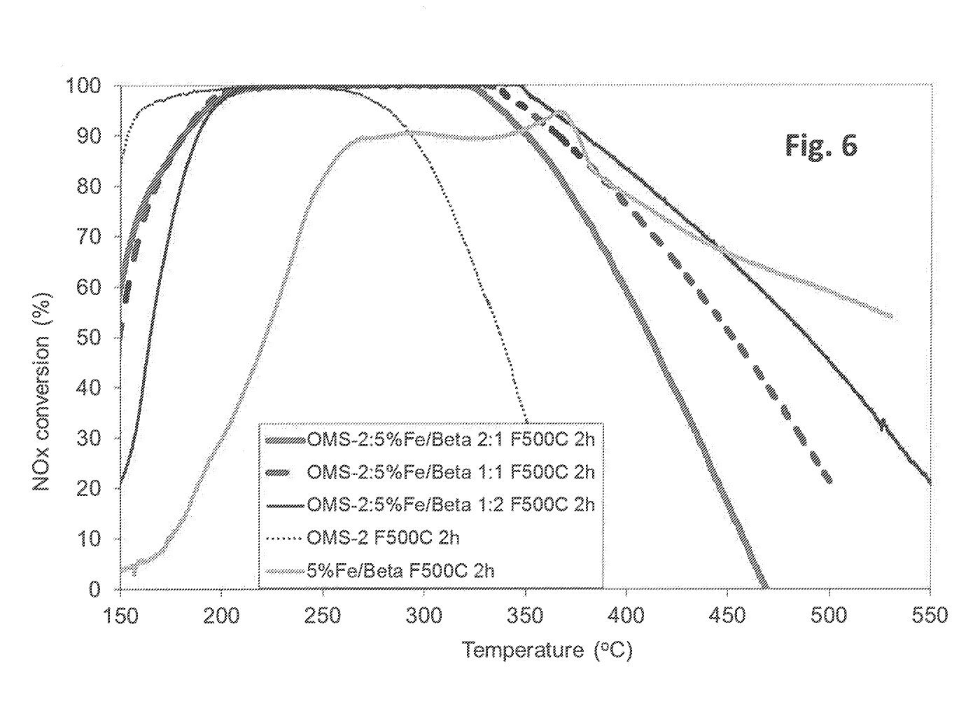

FIG. 6 shows the impact on NOx conversion of combining OMS-2 with 5 wt. % iron on β-zeolite at various weight ratios. All of the OMS-2/Fe β-zeolite mixtures extend the high-temperature range for NOx conversion (200° C. to 400° C.) when compared with OMS-2 alone. In each case, a small trade-off at the low-temperature end (150° C. to 200° C.) accompanies the gain at the high-temperature end. A higher proportion of β-zeolite (1 part OMS-2 to 2 parts of Fe β-zeolite) extends the high-temperature performance to a greater degree. A comparative plot of 5 wt. % Fe on β-zeolite shows that this catalyst has very low activity for NOx conversion in the low-temperature (150-250° C.) range.

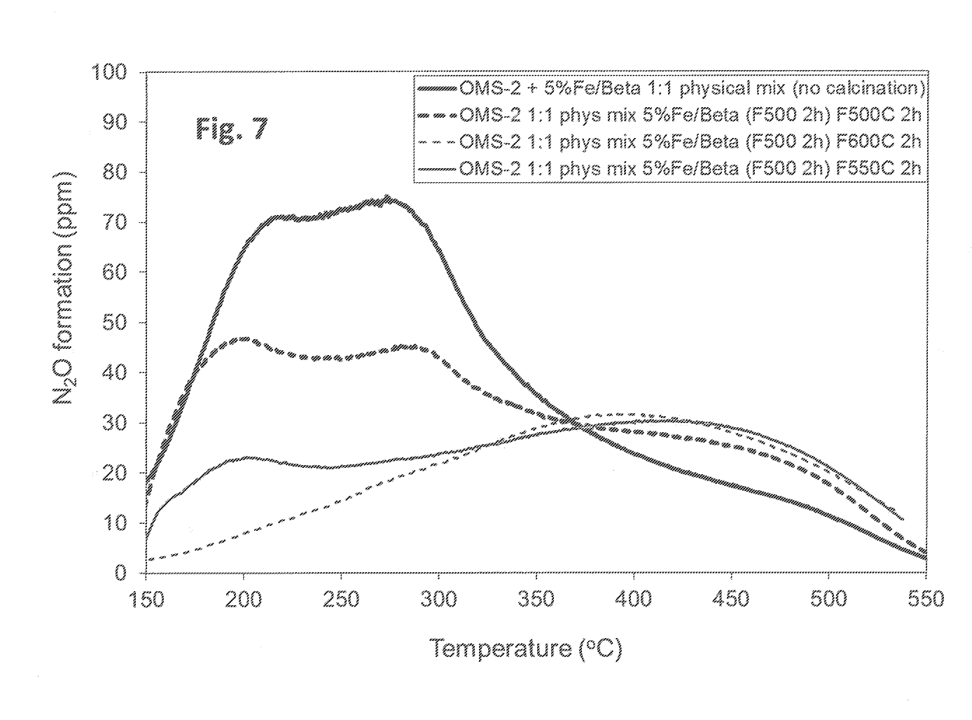

FIG. 7 demonstrates the benefits that calcination can have for N₂O generation. Without calcination, the OMS-2/Fe β-zeolite mixture generates a tolerable (70 ppm) level of N₂O in the 150° C. to 350° C. range, and much less than OMS-2 alone (see FIG. 1). However, calcining the catalyst at 500° C., 550° C., and 600° C. progressively reduces the N₂O make in the range of 150° C. to 350° C.

FIG. 8 shows that the additional reduction in N₂O afforded by calcination (FIG. 7) comes at the expense of a progressively narrower window of temperatures suitable for NOx conversion. Thus, when the catalyst is calcined at high temperature, it generates the least amount of N₂O, but it also sacrifices NOx conversion at both the low and high-temperature ends of the test.

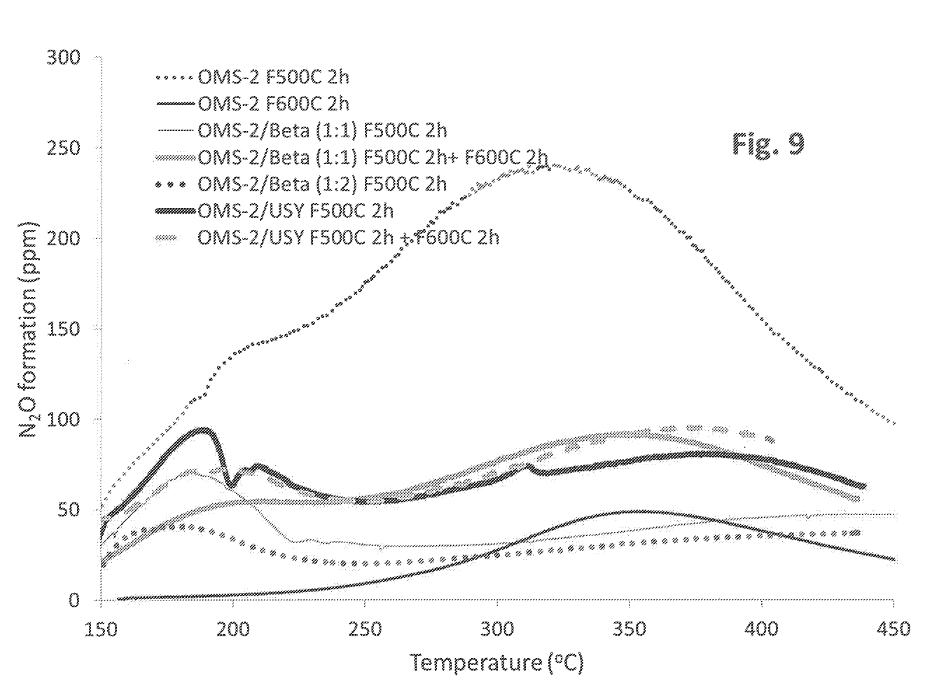

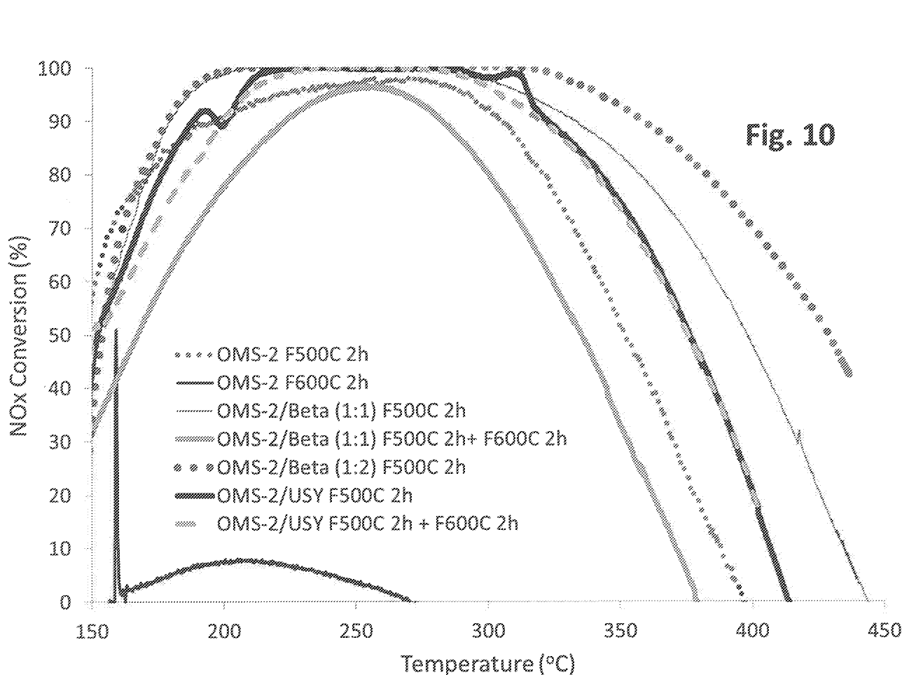

FIG. 9 shows that, compared with OMS-2 alone, composite catalysts of the invention made from OMS-2 and a large-pore zeolite (β-zeolite or ultra-stable Y-zeolite) form reduced levels of N₂O, with the best selectivity noted for the (1:2) composite of OMS-2 and β-zeolite. The OMS-2 catalyst calcined at 600° C. also forms little N₂O, but as shown in FIG. 10, it deactivates at the higher calcination temperature.

FIG. 10 shows that, compared with OMS-2 alone, composite catalysts of the invention have improved thermal stability. Moreover, NOx conversion generally improves at higher temperatures (350-400° C.) for the composite catalysts. Of the catalysts tested here, the OMS-2/β-zeolite (1:2) composite calcined at 500° C. is the most effective at NOx reduction over the widest temperature range.

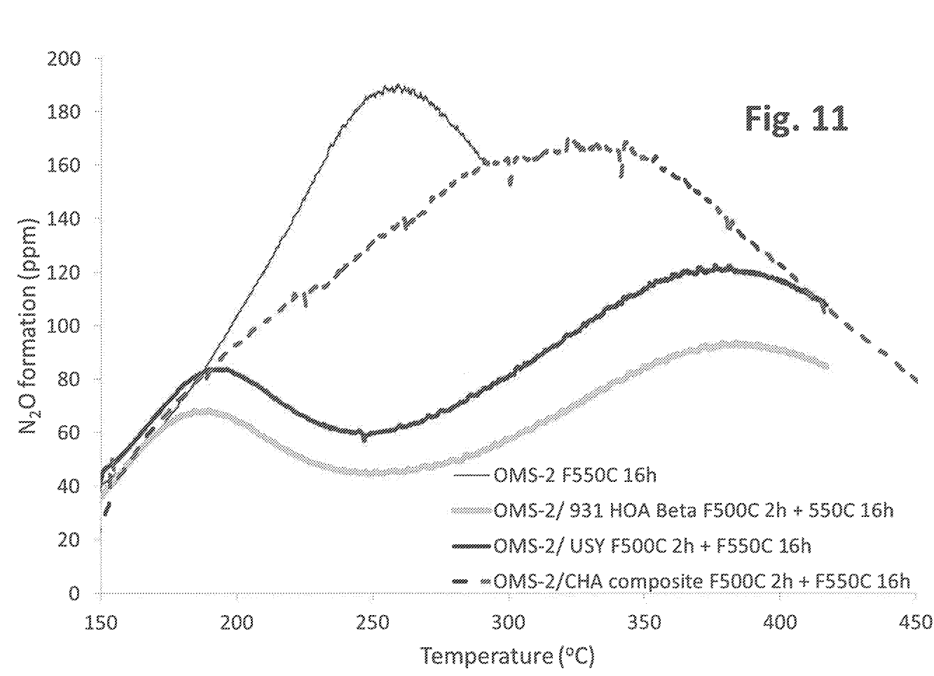

FIG. 11 shows the effects of thermal aging (calcination for 16 h at 550° C.) on N₂O formation. The aged catalysts based on composites of OMS-2 and ultra-stable Y-zeolite or β-zeolite (large-pore zeolites) produce less N₂O than an aged composite of OMS-2 and chabazite (a small-pore zeolite).

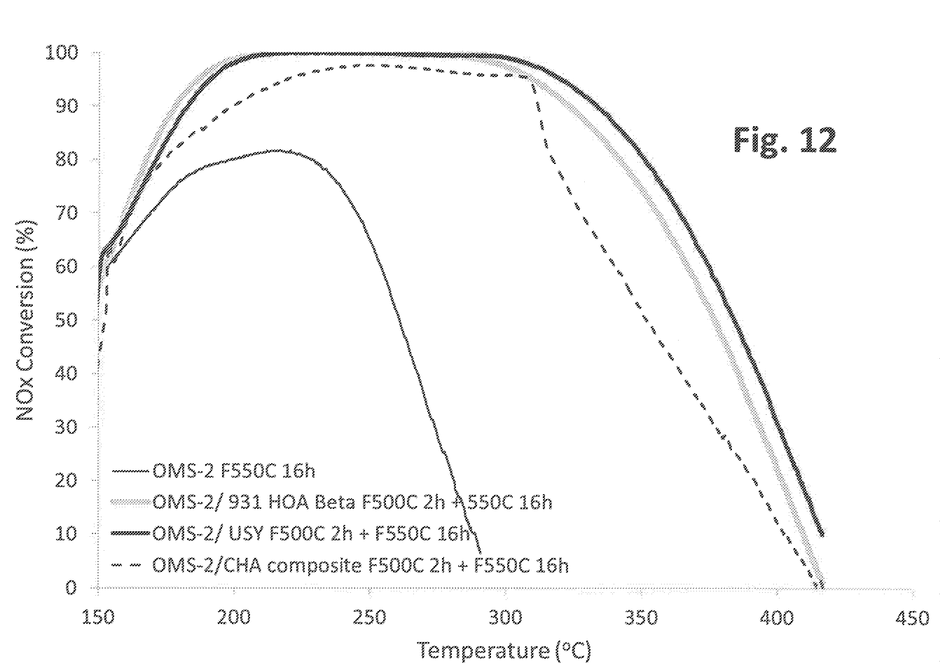

FIG. 12 shows that the composite catalysts retain activity for NOx conversion better upon thermal aging than OMS-2 alone. The aged catalysts based on composites of OMS-2 and ultra-stable Y-zeolite or β-zeolite reduce NOx effectively over a wider temperature range compared with an aged composite of OMS-2 and chabazite.

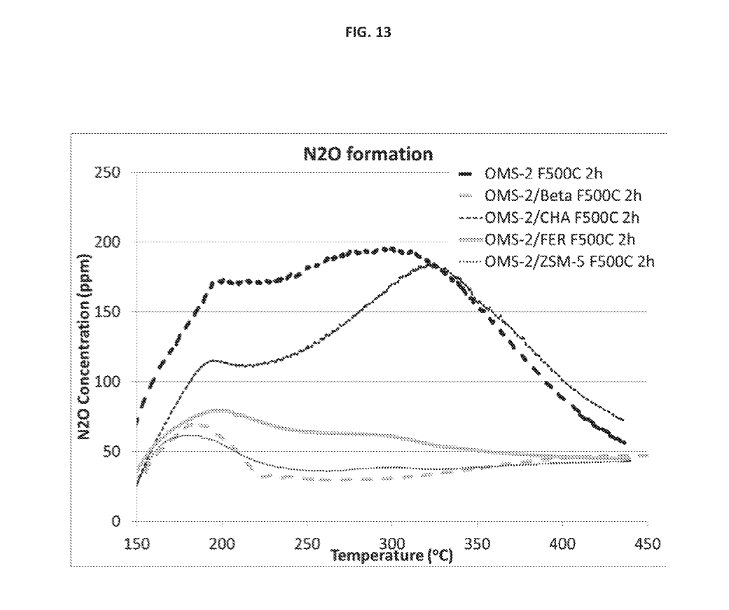

FIG. 13 illustrates the effect of combining OMS-2 with a metal loaded β-zeolite, a metal loaded FER-zeolite, and a metal loaded ZSM-5 zeolite. The medium-pore and large-pore zeolites with OMS-2 succeed in reducing N₂O formation compared with OMS-2 alone or OMS-2 plus a metal-loaded small pore zeolite (CHA) over a broad temperature range.

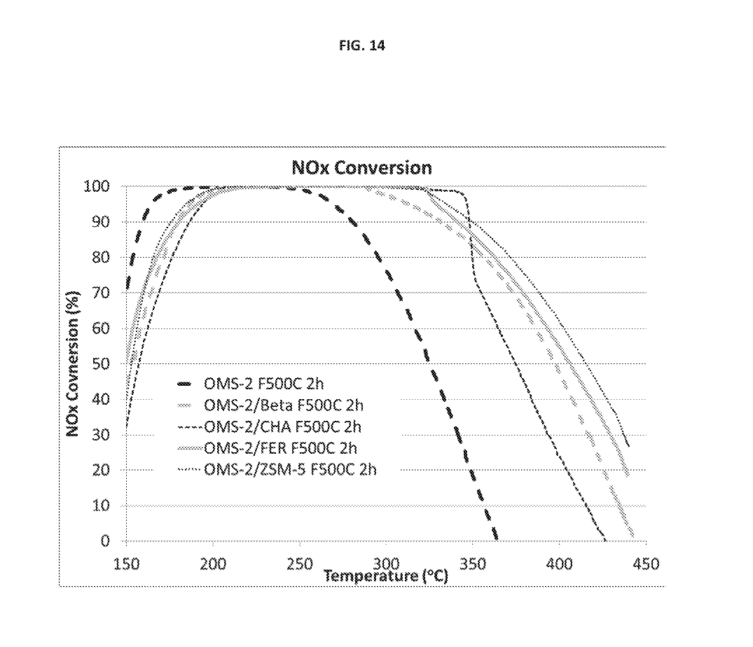

FIG. 14 illustrates the effect of combining OMS-2 with a metal loaded β-zeolite, a metal loaded FER-zeolite, and a metal loaded ZSM-5 zeolite. The medium-pore and large-pore zeolites with OMS-2 succeed in showed improved NOx conversion at low temperatures (e.g., below 200 deg. C.) compared to OMS-2 plus a metal-loaded small pore zeolite (CHA) and showed improved NOx conversion at high temperatures (e.g., above 360 deg. C.) compared to both OMS-2 plus a metal-loaded small pore zeolite (CHA) and OMS-2 alone.

The preceding examples are intended only as illustrations; the following claims define the scope of the invention.

We claim:

1. A catalyst useful for selective catalytic reduction, comprising:
(a) 1 to 99 wt. % of an octahedral molecular sieve (OMS) comprising manganese oxide; and
(b) 1 to 99 wt. % of a medium-pore and/or large-pore molecular sieve(s).

2. The catalyst of claim 1 wherein the molecular sieve further comprises iron or copper.

3. The catalyst of claim 2 comprising 0.1 to 10 wt. % of iron or copper on the molecular sieve.

4. The catalyst of claim 1 comprising 10 to 90 wt. % of the OMS and 90 to 10 wt. % of the molecular sieve.

5. The catalyst of claim 1 wherein the octahedral molecular sieve is OMS-2.

6. A composite catalyst of claim 1 wherein the OMS is formed in the presence of the molecular sieve.

7. The catalyst of claim 1 comprising a physical mixture of the OMS and the molecular sieve.

8. The catalyst of claim 1 wherein the OMS is deposited on the molecular sieve.

9. The catalyst of claim 1 wherein the OMS is doped with a metal selected from the group consisting of Ca, Ti, V, Cr, Fe, Co, Ni, Cu, Zn, Ce, Zr, Mo, W, and Pr.

10. The catalyst of claim 1 wherein the molecular sieve has a framework selected from the group consisting of Beta, ultra-stable Y, FER, and MFI.

11. A process which comprises selectively reducing a gaseous mixture comprising nitrogen oxides in the presence of a reductant and the catalyst of claim 1.

12. The process of claim 11 wherein the reductant is selected from the group consisting of ammonia and C₁-C₈ hydrocarbons.

13. The process of claim 12 wherein the reductant is ammonia.

14. The process of claim 11 wherein the catalyst comprises OMS-2 and a β-zeolite, FER-zeolite, Y-zeolite, FAU-zeolite, or MFI-zeolite.

15. The process of claim 14 wherein the OMS-2 is formed in the presence of the β-zeolite, FER-zeolite, Y-zeolite, FAU-zeolite, or MFI-zeolite.

16. The process of claim 14 wherein the catalyst is calcined at 300° C. to 750° C.

17. The process of claim 11 wherein the catalyst comprises OMS-2 and iron on β-zeolite, FER-zeolite, Y-zeolite, FAU-zeolite, or MFI-zeolite.

18. The process of claim 11 wherein % conversion of nitrogen oxides at temperatures greater than 300° C. improves compared with that of a similar process in which an OMS catalyst without the zeolite is used.

19. The process of claim 11 wherein % conversion of nitrogen oxides at temperatures from 150° C. to 250° C. improves compared with that of a similar process in which a zeolite catalyst without the OMS is used.

20. An article for treating an exhaust gas containing ammonia, comprising a substrate and, deposited on the substrate, a first layer or zone comprising a catalyst of claim 1 and a second layer or zone comprising an ammonia oxidation catalyst.
